(19) United States
(12) Patent Application Publication
(10) Pub. No.: US 2025/0035140 A1
(43) Pub. Date: Jan. 30, 2025

(54) COUPLER FOR SIGN POSTS

(71) Applicant: Indian Metal Solutions, Gujrat (IN)

(72) Inventors: Dhananjay Joshi, Gujrat (IN); Sachin Barve, Maharashtra (IN)

(73) Assignee: Indian Metal Solutions, Gujrat (IN)

(21) Appl. No.: 18/423,431

(22) Filed: Jan. 26, 2024

(30) Foreign Application Priority Data
Jul. 26, 2023 (IN) 202321050353

(51) Int. Cl. F16B 7/04

(52) U.S. Cl. CPC F16B 7/0413

(57) ABSTRACT

Disclosed is a coupler for engaging C shaped stakes of a signpost. The coupler comprises an inner hollow rectangular shaft member and an outer hollow rectangular shaft member. Specifically, the outer hollow rectangular shaft member surrounds the inner hollow rectangular shaft member. The coupler further comprises a plurality of veins configured to run vertically on inner surface of the outer hollow rectangular shaft member and outer surface of the inner hollow rectangular shaft member and a support member configured within the gap of the inner hollow rectangular shaft member and the outer hollow rectangular shaft member at midportion to support C shaped stake thereon and to stop another C shaped member to move upward from lower side.

### RELATED APPLICATIONS

This application claims priority of India Application No. 202321050353, filed Jul. 26, 2023, which is hereby incorporated herein by reference in its entirety.

### FIELD OF THE INVENTION

The present invention relates to a coupler for sign posts, and more particularly, the present invention provides coupler for the sign post which can stand wind load and can serve properly without failure.

### BACKGROUND OF THE INVENTION

Yard signs are commonly attached to posts. The yard sign typically includes an anchor that is driven into the ground, an extended support connected to the anchor and extending above the ground, and a sign attached to the support.

The yard sign or signpost generally includes a lower post/stake which can be removably attached to the anchor fixed to the ground and an upper post/stake which generally includes signpost attached at its upper end. These upper and lower posts are attached or coupled together by a coupler. The coupler holds the lower post and the upper post together.

The couplers connecting the upper post and the lower post should be strong enough to stand the high wind load on the highways.

One such prior art U.S. Pat. No. 8,667,719 discloses a three-sided channel coupler for connecting the upper and lower portions of a U-shaped sign post, the coupler comprising two U-shaped elements, an outer three-sided, U-shaped element and an inner, three-sided U-shaped element, the three sides of each element comprising a transverse face and two lateral legs, the inner element being smaller than the outer element, a plurality of cross-braces attached to the two lateral legs of each element to hold the two elements together and a plurality of vertical ribs on the inner surface of the outer element and on the outer surface of the inner element.

The above US prior art patent is directed towards better method of affixing multi-stake sign pieces together, that not only saves on shipping and packaging costs but would replace hole punching/screws, thereby saving on material and labor cost. However, the coupler disclosed in a prior art patent is not strong enough to hold the joined sign post from strong wind loads.

Accordingly, there exists a need to provide a coupler for the signposts which overcomes the drawbacks of the prior art.

### OBJECTS OF THE INVENTION

An object of the present invention is to provide a strong coupler for holding stakes of the signpost

Another object of the present invention is to provide coupler for holding stakes of the signposts which can withstand high wind loads.

### SUMMARY OF THE INVENTION

Accordingly, the present invention provides a coupler for engaging C shaped stakes of a signpost. The coupler has an upper portion for receiving a C shaped stake therein and a lower portion for receiving another C shaped stake therein.

The coupler comprises an inner hollow rectangular shaft member having a first side wall, a second side wall, a third side wall and a fourth side wall.

Further, the coupler comprises an outer hollow rectangular shaft member having a first side wall, a second side wall, a third side wall and a fourth side wall. Specifically, the outer hollow rectangular shaft member surrounds the inner hollow rectangular shaft member such that the first side wall, the second side wall, and a third side of the outer hollow rectangular shaft member is spaced apart with a predetermined gap from the first side wall, the second side wall, and the third side wall of the inner hollow rectangular shaft member and the fourth wall of the outer hollow rectangular shaft member and the fourth wall of the inner hollow rectangular shaft member merges with each other to form a single wall.

The coupler furthermore comprises a plurality of veins configured to run vertically on inner surface of the outer hollow rectangular shaft member and outer surface of the inner hollow rectangular shaft member.

The coupler also comprises a support member configured within the gap of the inner hollow rectangular shaft member and the outer hollow rectangular shaft member at midportion to support C shaped stake thereon and to stop another C shaped member to move upward from lower side.

Typically, wherein each vein of the plurality of veins are configured in anyone of M and W shape.

### BRIEF DESCRIPTION OF THE DRAWINGS

FIG. 1 shows a perspective view of a coupler with a stake placed therein, in accordance with the present invention;

FIG. 2 shows a perspective view of coupler in accordance with the present invention;

FIGS. 3 and 4 shows a cross sectional view of the coupler, in accordance with the present invention; and

FIG. 5 shows another cross sectional view of the coupler of FIG. 3.

### DETAILED DESCRIPTION OF THE INVENTION

The foregoing objects of the invention are accomplished and the problems and shortcomings associated with prior art techniques and approaches are overcome by the present invention described in the present embodiments.

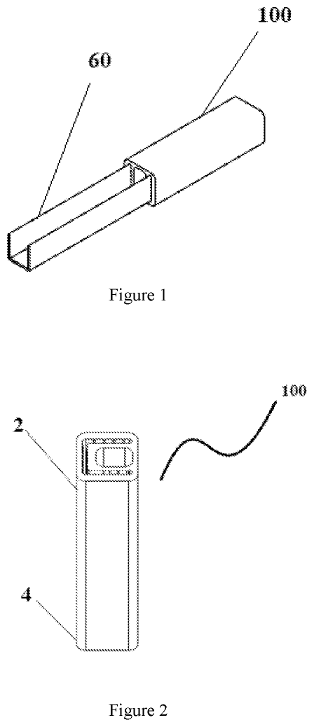

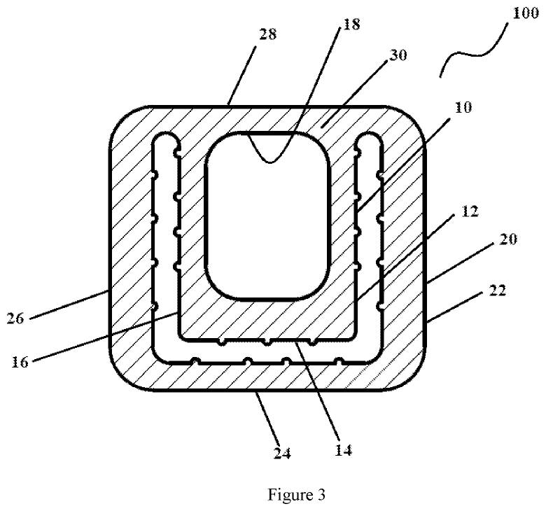

Referring now to FIG. 1 to 5, there is shown a coupler (100) for engaging C shaped stakes of a signpost. For the purpose of clarity, C shaped stake is a regular signboard stake made of metal available in the market. FIG. 1 shows a schematic drawing of the C shaped stake (60) engaged within the coupler (100). The coupler (100) of the present invention is capable of receiving one C shaped stake from upper end (2) thereof and second C shaped stake from lower end (4) thereof as shown in FIG. 2. In preferred embodiment, the lower stake is fixed to the ground on to which the coupler (100) slides.

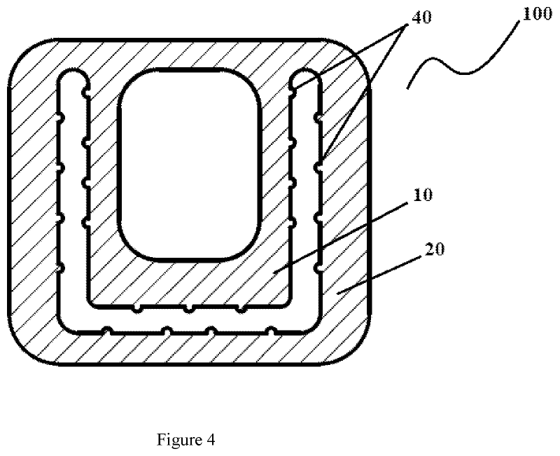

Referring now to FIG. 3, the coupler (100) is shown in accordance with the present invention. The coupler (100) o the present invention is strong coupler for holding stakes of the signboard. The coupler (100) is capable of receiving stakes therein firmly and withstands high wind loads.

The coupler (100) comprises an inner hollow rectangular shaft member (10) having a first side wall (12), a second side wall (14), a third side wall (16) and a fourth side wall (18). Specifically, the first side wall (12) and third side wall (16) lie opposite to each other and the second side wall (14) and the fourth side wall (18) lie opposite to each other to form the rectangular shaft member (10).

The coupler (100) further comprises an outer hollow rectangular shaft member (20) having a first side wall (22), a second side wall (24), a third side wall (26) and a fourth side wall (28). Specifically, the first side wall (22) and third side wall (26) lie opposite to each other and the second side wall (24) and the fourth side wall (28) lie opposite to each other to form rectangular shaft member (20). In preferred embodiment, the outer hollow rectangular shaft member (20) surrounds the inner hollow rectangular shaft member (10) such that the first side wall (22), the second side wall (24), and a third side wall (24) of the outer hollow rectangular shaft member (20) is spaced apart with a predetermined gap from the first side wall (12), the second side wall (14), and the third side wall (16) of the inner hollow rectangular shaft member (10).

Further, the fourth side wall (28) of the outer hollow rectangular shaft member (20) and the fourth side wall (18) of the inner hollow rectangular shaft member (10) merges with each other to form a single wall (30) with no space there between. This increases strength of the coupler (100).

In an embodiment, the single wall (30) of the coupler may be formed by merging the fourth side wall (28) of the outer hollow rectangular shaft member (20) and the fourth side wall (18) of the inner hollow rectangular shaft member (10).

In another embodiment, the wall (30) may be formed as a single wall while manufacturing the coupler (100) by elimination the need of merging two separate walls (18 and 28) to have outer hollow rectangular shaft member (20).

In an embodiment, the inner hollow rectangular shaft member (10) and the outer rectangular shaft member (20) are made from any one of polymer polypropylene, acetal, ABS, polycarbonate resins, polysulphide and poly carbon material. However, it may be evident to those skilled in the art to any suitable sturdy material which can withstand the high wind pressure.

In yet another embodiment, the outer hollow rectangular shaft member (20) has rounded external edges for safe handling of coupler (100) without safety gloves.

The coupler (100) further comprises a plurality of veins (40) configured to run vertically on inner surface of the outer hollow rectangular shaft member (20) and outer surface of the inner hollow rectangular shaft member (10) as shown in FIG. 4. In preferred embodiment each vein of the plurality of veins (40) are configured in anyone of M and W shape. This feature of the veins (40) provides resistance and friction between the coupler (100) and C shaped stake and avoid slippage as the C shaped stakes which are generally made of aluminum which tend to slip within the coupler, making them loose fit.

In an embodiment, the plurality of veins (40) are made integral part of the inner hollow rectangular member (10) and outer hollow rectangular member (20) and manufactured as a single unit.

In one embodiment, the plurality of veins (40) on the inner hollow rectangular shaft member (10) and the outer hollow rectangular shaft member (20) are configured diagonally opposite to each other. This is represented in FIGS. 3 and 4 of the present invention.

In an embodiment, each vein the plurality of veins (40) on the inner hollow rectangular shaft member (10) and the outer hollow rectangular shaft member (20) are configured opposite to each other. Specifically, the plurality of veins (40) add stability to the inner hollow rectangular shaft member (10) and the outer hollow rectangular shaft member (20) and act as structural support across the length that prevents warpage or bending of the coupler (100).

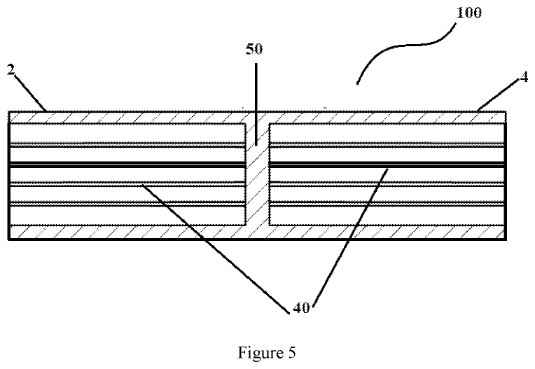

The coupler (100) furthermore comprises a support member (50) configured within the gap of the inner hollow rectangular shaft member (10) and the outer hollow rectangular shaft member (20) at midportion to support C shaped stake thereon and to stop another C shaped member to move upward from lower side. In an embodiment, the support member (50) is rigid structure capable of sustaining the load. The support member (50) of the coupler member (100) is shown in cross sectional view of FIG. 5.

From the analysis of the coupler (100), it is observed that the coupler (100) has higher strength than the as compared to the coupler of the prior art.

Further, the coupler (100) has more strength and durability perspective. The coupler (100) has higher braking strength against bending loads, twisting loads and requires higher braking force. Specifically, the coupler (100) can sustain higher wind loads and loads, in comparison to coupler of the prior art and can have higher life.

Furthermore, the coupler of the prior art has excessive deformation and pre-stress and also deforms the C-channel while the coupler (100) of the present invention has higher stiffens because of its four wall structure, more uniform section, and doesn't deform the channel.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the scope of the claims of the present invention.

We claim:

1. A coupler for engaging C shaped stakes of a signpost, the coupler having an upper portion for receiving a C shaped stake therein and a lower portion for receiving another C shaped stake therein, the coupler comprising;
an inner hollow rectangular shaft member having a first side wall, a second side wall, a third side wall and a fourth side wall;
an outer hollow rectangular shaft member having a first side wall, a second side wall, a third side wall and a fourth side wall, the outer hollow rectangular shaft member surrounds the inner hollow rectangular shaft member such that the first side wall, the second side wall, and a third side of the outer hollow rectangular shaft member is spaced apart with a predetermined gap from the first side wall, the second side wall, and the third side wall of the inner hollow rectangular shaft member and the fourth wall of the outer hollow rectangular shaft member and the fourth wall of the inner hollow rectangular shaft member merges with each other to form a single wall;
a plurality of veins configured to run vertically on inner surface of the outer hollow rectangular shaft member and outer surface of the inner hollow rectangular shaft member; and
a support member configured within the gap of the inner hollow rectangular shaft member and the outer hollow rectangular shaft member at midportion to support C shaped stake thereon and to stop another C shaped member to move upward from lower side.

2. The coupler as claimed in claim 1, wherein each vein of the plurality of veins are configured in anyone of M and W shape.

3. The coupler as claimed in claim 1, wherein the inner hollow rectangular shaft member and the outer rectangular shaft member are made from any one of polymer polypropylene, acetal, ABS, polycarbonate resins, polysulphide and poly carbon material.

4. The coupler as claimed in claim 1, wherein the plurality of veins on the inner hollow rectangular shaft member and the outer hollow rectangular shaft member are configured opposite to each other.

5. The coupler as claimed in claim 1, wherein the plurality of veins on the inner hollow rectangular shaft member and the outer hollow rectangular shaft member are configured diagonally opposite to each other.

6. The coupler as claimed in claim 1, wherein the support member is rigid structure capable of sustaining the load.

7. The coupler as claimed in claim 1, wherein the outer hollow rectangular shaft member has rounded external edges.
